(19) United States
(12) Patent Application Publication
(10) Pub. No.: US 2024/0144693 A1
(43) Pub. Date: May 2, 2024

(54) INFORMATION COLLECTING DEVICE, SERVER, AND INFORMATION COLLECTING METHOD

(71) Applicant: Mitsubishi Electric Corporation, Tokyo (JP)

(72) Inventor: Takuya KONO, Tokyo (JP)

(73) Assignee: Mitsubishi Electric Corporation, Tokyo (JP)

(21) Appl. No.: 18/279,789

(22) PCT Filed: Apr. 9, 2021
(86) PCT No.: PCT/JP2021/015003

§ 371 Date: Aug. 31, 2023

(51) Int. Cl. G06V 20/56; G06T 7/11; G06T 7/70

(52) U.S. Cl. CPC G06V 20/56; G06T 7/11; G06T 7/70; G06T 2207/30252

(57) ABSTRACT

An information collecting device to collect an image and position information to be transmitted from a vehicle to an external server via a communication network includes an image acquisition unit to acquire the image of the outside of the vehicle obtained by capturing by an image-capturing device mounted on the vehicle, a position-information acquisition unit to acquire position information indicating a capturing position of the image, a resource-status acquisition unit to acquire resource information indicating a status of a resource related to a load of processing on the image, a processing-method determination unit to determine a processing method of the image in accordance with the status of the resource, an image processing unit to process the image in accordance with the processing method, and an image analysis unit to perform analysis of the image processed and output the image processed in accordance with a result of the analysis.

### TECHNICAL FIELD

The present disclosure relates to an information collecting device that collects an image of the outside of a vehicle obtained by capturing from the vehicle for the purpose of abnormality detection of an image-capturing target.

### BACKGROUND ART

Among conventional techniques of collecting an image for abnormality detection, there is a technique of transmitting an image of the outside of a vehicle obtained by capturing from the vehicle to an external server or the like via a communication network. Such an image is generally large in data size, and thus is transmitted after being compressed so that transmission does not fail.

Meanwhile, Patent Literature 1 discloses an image processing apparatus that divides an image on the basis of a viewpoint of an area to be noted by a driver who drives a vehicle, and performs different compression processing on the individual divided areas.

Specifically, the image processing apparatus sets an importance level higher in an area that is easily overlooked by the driver of the host vehicle or that is likely to have an object to be noted by the driver, and simplifies the compression processing in a captured image of an area with a lower importance level.

### CITATION LIST

### Patent Literatures

Patent Literature 1: JP 2019-47401 A

### SUMMARY OF INVENTION

### Technical Problem

The conventional technique has a problem that information indicating an abnormality of an object in an image may be lost when the image is compressed.

The image processing apparatus of Patent Literature 1 performs different compression processing in the individual areas obtained by dividing an image on the basis of a viewpoint of an area to be noted by a driver who drives a vehicle, and cannot solve the above problem.

The present disclosure has been made to solve the above problem, and an object of the present disclosure is to provide an information collecting device in which information indicating an abnormality of an object in an image is hardly lost when the image is collected.

### Solution to Problem

An information collecting device according to the present disclosure collects an image and position information to be transmitted from a vehicle to an external server via a communication network. The information collecting device includes: an image acquisition unit to acquire the image of outside of the vehicle obtained by capturing by an image-capturing device mounted on the vehicle; a position-information acquisition unit to acquire position information indicating a capturing position of the image acquired by the image acquisition unit; a resource-status acquisition unit to acquire resource information indicating a status of a resource related to a load of processing on the image; a processing-method determination unit to determine a processing method of the image in accordance with the status of the resource indicated by the resource information acquired by the resource-status acquisition unit; an image processing unit to process the image in accordance with the processing method determined by the processing-method determination unit; and an image analysis unit to perform analysis of the image processed by the image processing unit and output the image processed in accordance with a result of the analysis.

### Advantageous Effects of Invention

With the configuration described above, the present disclosure can provide the information collecting device in which the information indicating the abnormality of the object in the image is hardly lost when the image is collected.

### BRIEF DESCRIPTION OF DRAWINGS

FIG. 1 is a diagram illustrating a configuration of an abnormality detection system including an information collecting device according to a first embodiment.

FIG. 2 is a diagram illustrating an example of criteria for determining a processing method in the information collecting device according to the first embodiment.

FIG. 3 is a flowchart illustrating processing performed by the information collecting device according to the first embodiment.

FIG. 4 is a diagram illustrating a concept of the processing performed by the information collecting device.

FIG. 5 is a diagram illustrating a first example of a hardware configuration of the abnormality detection system including the information collecting device.

FIG. 6 is a diagram illustrating a second example of the hardware configuration of the abnormality detection system including the information collecting device.

FIG. 7 is a diagram illustrating a configuration of an abnormality detection system including an information collecting device and a server according to a second embodiment.

FIG. 8 is a diagram illustrating a configuration of the server according to the second embodiment.

FIG. 9 is a diagram illustrating an example of criteria for determining a processing method in the server according to the second embodiment.

FIG. 10 is a diagram illustrating a first concept example of the contents of commands from the server to the information collecting device.

FIG. 11 is a diagram illustrating a second concept example of the contents of commands from the server to the information collecting device.

FIG. 12 is a flowchart illustrating an example of processing performed by the information collecting device according to the second embodiment.

FIG. 13 is a flowchart illustrating an example of processing in step ST220 in FIG. 12.

FIG. 14 is a flowchart illustrating an example of processing in step ST230 in FIG. 12.

FIG. 15 is a flowchart illustrating an example of processing in the server according to the second embodiment.

### DESCRIPTION OF EMBODIMENTS

Hereinafter, in order to describe the present disclosure in more detail, some modes for carrying out the present disclosure will be described with reference to the accompanying drawings.

### First Embodiment

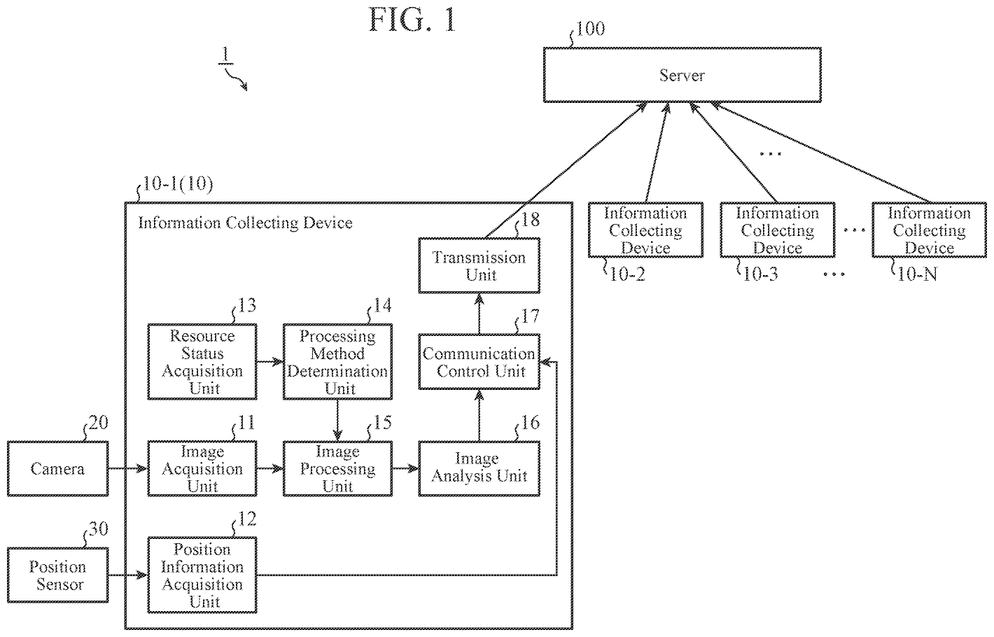

FIG. 1 is a diagram illustrating a configuration of an abnormality detection system 1 including an information collecting device 10 according to a first embodiment.

The abnormality detection system 1 illustrated in FIG. 1 detects whether an object in an image of the outside of a vehicle obtained by capturing from the vehicle is in an abnormal state.

The abnormality detection system 1 includes the information collecting device 10, a camera 20, and a position sensor 30 mounted on each vehicle, and a server 100 provided outside the vehicle.

The information collecting device and the server 100 are communicably connected via a communication network (not illustrated).

In the abnormality detection system 1 illustrated in FIG. 1, in a case where the information collecting device 10 detects an abnormality of an object in an image captured by the camera 20 by simple analysis processing, the image is transmitted to the server 100, and the server 100 performs more detailed analysis processing on the abnormality of the object using collected images.

The object of abnormality detection is, for example, a road.

In this case, for example, the abnormality of conditions on roads such as unevenness of pavement is detected. More specifically, there may be abnormalities such as a state where a white line on a road is missing, a pot hole on a road, and a broken or misaligned manhole.

In addition, the object of abnormality detection may include, for example, a structure provided around a road such as a traffic light or a wall surface of a tunnel.

In this case, for example, an abnormality around a road such as the damage of a traffic light or a crack on a wall surface of a tunnel is detected.

The camera 20 is an example of a capturing device in the abnormality detection system 1, and is mounted on each of a plurality of different vehicles.

The camera 20 continuously captures the outside of the vehicle from the vehicle and outputs the captured image.

The image includes a plurality of frames with different captured times.

The position sensor 30 is mounted on each of a plurality of different vehicles.

The position sensor 30 measures the position of the vehicle at predetermined time intervals using, for example, a GPS technology, and outputs position information indicating the position of the vehicle.

The information collecting device 10 is mounted on each of a plurality of different vehicles, and is communicably connected to the camera 20 and the position sensor 30 mounted on the vehicle.

Furthermore, the information collecting device 10 and the external server 100 are communicably connected via a communication network.

The information collecting device 10 collects an image to be transmitted to the external server 100 via the communication network and position information indicating a position where the image is captured.

Specifically, the information collecting device 10 acquires an image from the camera 20 and acquires position information from the position sensor 30. The acquired position information indicates the position of a point where the image is captured.

When performing an analysis using the image and the position information and detecting an abnormality of the object in the image, the information collecting device 10 transmits the image and the position information to the server 100.

In FIG. 1, an information collecting device 10-1, an information collecting device 10-2, an information collecting devices 10-3, . . . , and an information collecting device 10-N (N is an integer of 1 or more) are illustrated separately. Note that, in the description, in a case where it is not particularly necessary to indicate the information collecting devices separately, it is simply referred to as “information collecting device 10”.

A detailed configuration of the information collecting device 10 will be described later.

The server 100 is communicably connected to a plurality of information collecting devices 10 via the communication network.

The server 100 collects an image for analyzing an abnormality of an object in the image from each of the information collecting devices 10.

In addition, the server 100 analyzes the collected image and detects details of the abnormality of the object in the image.

Specifically, the server 100 receives the image and the position information from each of the plurality of different information collecting devices 10, and stores the image and the position information.

Then, for example, from a plurality of images with the same position indicated by the position information, the images are analyzed by using the images and the position information, and details of the abnormality of the object captured in the images are detected by the analysis processing.

Note that the server 100 may be implemented by, for example, a cloud server, and thus does not need to include a physical server. In addition, it is possible to construct the abnormality detection system 1 with an appropriate scale in accordance with the region to be analyzed.

A detailed configuration of the information collecting device 10 will be described.

The information collecting device 10 includes an image acquisition unit 11, a position-information acquisition unit 12, a resource-status acquisition unit 13, a processing-method determination unit 14, an image processing unit 15, an image analysis unit 16, a communication control unit 17, and a transmission unit 18.

In addition, the information collecting device 10 includes a storage unit 102 and a control unit (both are not illustrated).

The image acquisition unit 11 acquires an image of the outside of the vehicle obtained by capturing using an image-capturing device mounted on the vehicle.

The position-information acquisition unit 12 acquires position information indicating a position (an image-capturing point) where the image is acquired by the image acquisition unit 11.

Specifically, when the image acquisition unit 11 acquires an image from the image-capturing device, the position-information acquisition unit 12 acquires position information from the position sensor 30.

The resource-status acquisition unit 13 acquires resource information indicating a status of resources related to a load of processing on an image.

The status of resources indicated by the resource information is related to the load of processing on the image, such as the status of calculation resources performing the processing and the resolution of the image. For example, it includes at least one of the usage rate of the CPU of the information collecting device 10 (hereinafter, also referred to as “CPU usage rate”), the usage rate of the memory of the information collecting device 10 (hereinafter, also referred to as “memory usage rate”), or the resolution of the camera 20 (hereinafter, also simply referred to as “resolution”).

The resource-status acquisition unit 13 transmits the resource information to the processing-method determination unit 14.

The processing-method determination unit 14 determines a processing method to be applied to an image in accordance with the status of the resources indicated by the resource information.

The processing method includes the number of divisions of each image and the compression scheme of each divided area.

The compression scheme includes a plurality of compression schemes with different compression rates, and may be, for example, simply “uncompression” or “compression”.

In the description, the area determined to be uncompressed is referred to as “uncompression area”, and the area determined to be compressed is referred to as “compression area”.

Specifically, the processing-method determination unit 14 stores in advance the number of divisions and the compression scheme for each of or each combination of the CPU usage rate, the memory usage rate, and the resolution.

The processing-method determination unit 14 determines the number of divisions in accordance with at least one of the CPU usage rate, the memory usage rate, or the resolution.

In addition, by determining the compression scheme for each divided area, the processing-method determination unit 14 determines the uncompression area and the compression area.

The compression scheme of the uncompression area is a scheme in which the compression processing is not performed, and the processing is performed with the amount of information included in the image captured by the camera 20 as it is and without any information loss.

Note that the compression scheme of the uncompression area is only required to be a compression scheme with less information loss and a larger data size as compared with the compression scheme of the compression area.

Note that the compression scheme of the compression area is a compression scheme with larger information loss and a less data size as compared with the compression scheme of the uncompression area.

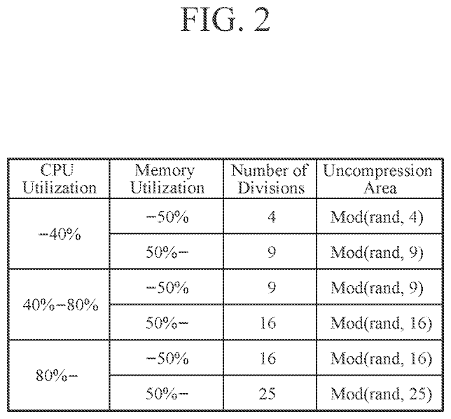

FIG. 2 is a diagram illustrating an example of criteria for determining a processing method in the information collecting device 10 according to the first embodiment.

FIG. 2 illustrates an example of criteria in a case where a combination of the CPU usage rate and the memory usage rate and the number of divisions and one uncompression area are determined.

In FIG. 2, Mod (rand, (number of divisions)) represents the remainder when the value of a randomly extracted natural number (rand) is divided by the number of divisions.

The processing-method determination unit 14 determines the number of divisions and the uncompression area on the basis of the resource information with reference to the criteria illustrated in FIG. 2.

For example, when determining that the CPU usage rate is less than 40% and the memory usage rate is less than 50%, the processing-method determination unit 14 determines the number of divisions to be 4, and calculates and determines an identification number indicating each of the four divided areas.

For example, when determining that the CPU usage rate is less than 40% and the memory usage rate is equal to or more than 50%, the processing-method determination unit 14 determines the number of divisions to be 9, and calculates and determines an identification number indicating any one of the nine divided areas.

For example, when determining that the CPU usage rate is equal to or more than 40% and equal to or less than 80%, and the memory usage rate is less than 50%, the processing-method determination unit 14 determines the number of divisions to be 9, and calculates and determines an identification number indicating each of the nine divided areas.

For example, when determining that the CPU usage rate is equal to or more than 40% and equal to or less than 80%, and the memory usage rate is equal to or more than 50%, the processing-method determination unit 14 determines the number of divisions to be 16, and calculates and determines an identification number indicating each of the sixteen divided areas.

For example, when determining that the CPU usage rate exceeds 80% and the memory usage rate is less than 50%, the processing-method determination unit 14 determines the number of divisions to be 16, and calculates and determines an identification number indicating each of the sixteen divided areas.

For example, when determining that the CPU usage rate is exceeds 80% and the memory usage rate is equal to or more than 50%, the processing-method determination unit 14 determines the number of divisions to be 25, and calculates and determines an identification number indicating each of the twenty-five divided areas.

The image processing unit 15 processes the image in accordance with the processing method determined by the processing-method determination unit 14.

Specifically, the image processing unit 15 receives the number of divisions and information indicating the compression scheme of each of the divided areas determined by the processing-method determination unit 14.

The image processing unit 15 divides the image in accordance with the number of divisions, processes the uncompression area so as not to have an information loss in accordance with the information (the uncompression area or the compression area) indicating the compression scheme of each area, and performs the compression processing on the compression area so as to reduce a data size.

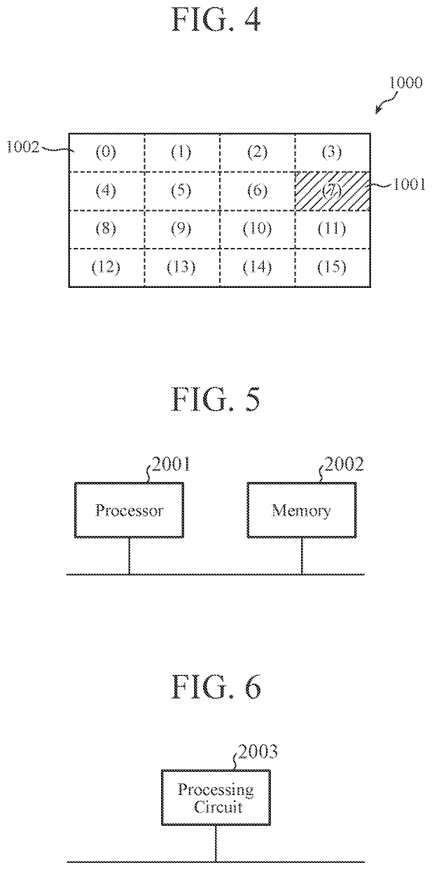

When dividing the image, the image processing unit 15 assigns an identification number to each of the divided areas. For example, an identification number (0) is assigned to the top left area in the image, an identification number (1) is assigned to the right adjacent area, and an identification number is similarly assigned to the top right area. Next, the identification number is assigned to the area immediately below the top left area, and the identification number is similarly assigned to the area immediately below the top right area. By repeating such an operation, identification numbers are assigned to all the areas up to the right bottom area. In a case where the number of divisions is 9, the identification numbers are (0) to (8), and in a case where the number of divisions is 16 (see FIG. 4 to be described later), the identification numbers are (0) to (15). Hereinafter, in the description, the area assigned with an identification number (n) is also referred to as “area (n)”.

The image analysis unit 16 is a first image analysis unit in the abnormality detection system 1.

The image analysis unit 16 analyzes the image processed by the image processing unit 15, and outputs an image in accordance with an analysis result.

Specifically, the image analysis unit 16 receives the processed image from the image processing unit 15, and performs analysis processing on the image for the purpose of detecting an abnormality of an object in the image.

The analysis processing itself for detecting an abnormality from an image is a known technique, and a detailed description thereof will be omitted.

As a result of the analysis processing, the image analysis unit 16 generates state information indicating whether or not an abnormality is included in each area, and outputs an image of an area including the abnormality and the state information.

The communication control unit 17 transmits the image output by the image analysis unit 16 and the position information acquired by the position-information acquisition unit 12 to the external server 100 via the transmission unit 18 and the communication network.

Specifically, the communication control unit 17 adds information designating the external server 100 to the image and the position information, and outputs the image and the position information to the transmission unit 18.

Upon receiving a command from the communication control unit 17, the transmission unit 18 transmits the image and the state information to the server 100 via the communication network.

The transmission unit 18 is, for example, a communication modem.

A control unit (not illustrated) controls the inside of the information collecting device 10.

A storage unit (not illustrated) temporarily stores an image and position information, for example.

The processing performed by the information collecting device 10 will be described. In the description, the case where the criteria illustrated in FIG. 2 are used is described, and the CPU usage rate is assumed to be 60% and the memory usage rate is assumed to be 60%.

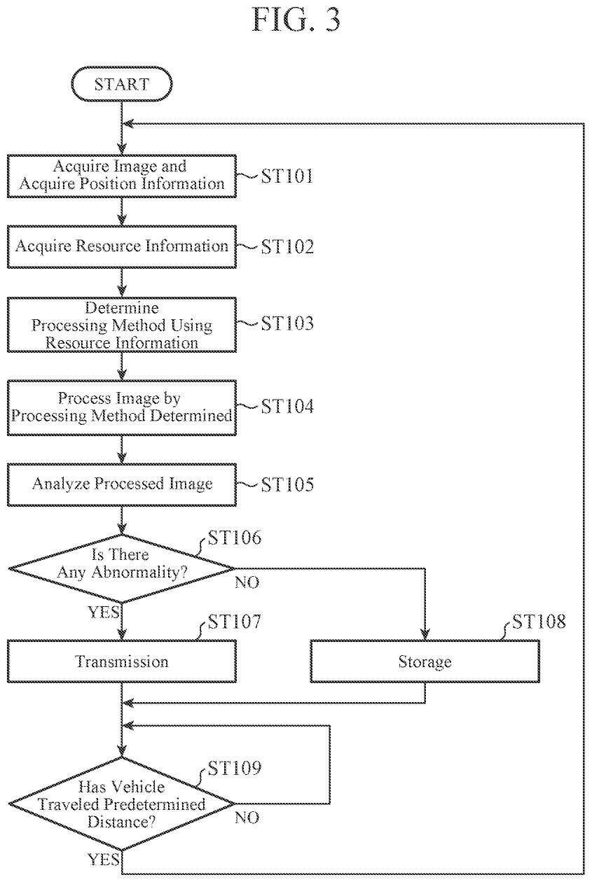

FIG. 3 is a flowchart illustrating the processing performed by the information collecting device 10 according to the first embodiment.

FIG. 4 is a diagram illustrating a concept of the processing performed by the information collecting device 10.

The information collecting device 10 starts processing on the basis of activation or a start operation from a user.

The information collecting device 10 acquires an image and also acquires position information (step ST101).

Specifically, when the image acquisition unit 11 in the information collecting device 10 acquires an image from the camera 20 and the image acquisition unit 11 acquires the image, the position-information acquisition unit 12 acquires position information from the position sensor 30.

The image acquisition unit 11 outputs the acquired image. The output image is transmitted to the image processing unit 15.

The position-information acquisition unit 12 outputs the acquired position information. The output position information is transmitted to the communication control unit 17.

The resource-status acquisition unit checks the CPU and the memory in the information collecting device 10, and acquires resource information including the CPU usage rate and the memory usage rate (step ST102).

The resource-status acquisition unit outputs the resource information.

The output resource information is transmitted to the processing-method determination unit 14.

The processing-method determination unit 14 determines a processing method using the resource information (step ST103).

Specifically, the processing-method determination unit 14 recognizes that the CPU usage rate is 60% and the memory usage rate is 60% on the basis of the resource information. Next, the processing-method determination unit 14 determines the number of divisions to be 16 with reference to the criteria illustrated in FIG. 2. Next, the processing-method determination unit 14 selects one area from sixteen areas and determines the selected area as an uncompression area. Here, it is assumed that the area (7) illustrated in FIG. 4 is determined as the uncompression area.

The processing-method determination unit 14 outputs processing method information indicating the number of divisions “16” and the uncompression area “(7)”.

The output processing method information is transmitted to the image processing unit 15.

The image processing unit 15 processes the image by the processing method determined by the processing-method determination unit 14 (step ST104).

Specifically, the image processing unit 15 receives the processing method information, and acquires the number of divisions “16” and the uncompression area “(7)” on the basis of the processing method information. Subsequently, as illustrated in FIG. 4, the image processing unit 15 equally divides an image 1000 received from the image acquisition unit 11 into images whose number of divisions is “16”. Then, the image processing unit 15 assigns identification numbers (0) to (15) to the divided areas sequentially from the top left area to the bottom right area. The identification number of each area is added to the header of area-based data, for example. Subsequently, on the basis of the uncompression area “(7)”, as illustrated in FIG. 4, the image processing unit 15 processes the area (7) as an uncompression area 1001, and also the compression processing on an area (0), an area (1), an area (2), an area (3), an area (4), an area (5), an area (6), an area (8), an area (9), an area (10), an area (11), an area (12), an area (13), an area (14), and an area (15) as compression areas 1002.

The image processing unit 15 outputs the processed image 1000.

The output image 1000 is transmitted to the image analysis unit 16.

The image analysis unit 16 analyzes the processed image (step ST105).

The image analysis unit 16 analyzes whether there is an abnormality of an object in the image and determines whether there is an abnormality of the object in the image (step ST106).

When determining that there is an abnormality (step ST106 “YES”), the image analysis unit 16 transmits the image to the communication control unit 17.

The communication control unit 17 transmits the image and the position information to the server 100 via the transmission unit 18 (step ST107).

When determining that there is no abnormality (step ST106 “NO”), the image analysis unit 16 stores the image in a storage unit (not illustrated) (step ST108).

Note that the image stored in the storage unit may be discarded after a predetermined time.

When the processing in step ST107 or step ST108 ends, the control unit (not illustrated) in the information collecting device 10 determines whether the vehicle has traveled a predetermined distance (step ST109).

The control unit (not illustrated) repeats step ST109 until the vehicle travels a predetermined distance, and when determining that the vehicle has traveled a predetermined distance (step ST109 “YES”), the control unit executes control to repeat the processing from step ST101.

The hardware configuration of the information collecting device 10 will be described.

The information collecting device 10 is assumed to include a processing circuit for implementing the functions of the configuration units in the information collecting device 10, which have been described above. The processing circuit may be a processing circuit as dedicated hardware, or may be a processor that executes programs stored in a memory.

FIG. 5 is a diagram illustrating a first example of a hardware configuration of the information collection system including the information collecting device 10.

In a case where the processing circuit is a processor 2001 as illustrated in FIG. 5, the function of each configuration unit in the information collecting device 10 is implemented by software, firmware, or a combination of software and firmware. Software or firmware is described as a program and stored in a memory 2002. By reading and executing the program stored in the memory 2002, the processor 2001 implements the functions of each of the units. That is, the information collecting device 10 includes the memory 2002 for storing a program that is executed by the processor 2001 to perform steps illustrated in the flowcharts illustrated in FIG. 3 and the like. It can also be said that this program causes a computer to perform procedures or methods performed in the configuration units in the information collecting device 10.

Here, the processor 2001 is a central processing unit (CPU), a processing device, an arithmetic device, a microprocessor or the like.

The memory 2002 may be a nonvolatile or volatile semiconductor memory such as a random access memory (RAM), a read only memory (ROM), an erasable programmable ROM (EPROM), or a flash memory, or may be a magnetic disk such as a hard disk or a flexible disk, or may be an optical disk such as a compact disc (CD) or a digital versatile disc (DVD).

Note that a part of the functions of the configuration units in the information collecting device 10 may be implemented by dedicated hardware, whereas a part thereof may be implemented by software or firmware. As described above, the configuration units in the information collecting device 10 can implement the functions by hardware, software, firmware, or a combination thereof.

FIG. 6 is a diagram illustrating a second example of the hardware configuration of the information collection system including the information collecting device 10.

As illustrated in FIG. 6, in a case where the processing circuit is dedicated hardware, a processing circuit 2003 corresponds to, for example, a single circuit, a composite circuit, a programmed processor, a parallel programmed processor, an application specific integrated circuit (ASIC), a field-programmable gate array (FPGA), a system-on-a-chip (SoC), or a combination thereof. The functions of the configuration units in the information collecting device 1010 can be implemented by a plurality of processing circuits 2003, or these functions can be collectively implemented by one processing circuit 2003.

As described above, the information collecting device according to the first embodiment collects an image and position information to be transmitted from a vehicle to an external server via a communication network, the information collecting device including an image acquisition unit to acquire an image of the outside of the vehicle obtained by capturing by an image-capturing device mounted on the vehicle, a position-information acquisition unit to acquire position information indicating a capturing position of an image acquired by the image acquisition unit, a resource-status acquisition unit to acquire resource information indicating a status of a resource related to a load of processing on an image, a processing-method determination unit to determine a processing method to be applied to an image in accordance with a status of a resource indicated by resource information acquired by the resource-status acquisition unit, an image processing unit to process an image in accordance with a processing method determined by the processing-method determination unit, and an image analysis unit to analyze an image processed by the image processing unit and output the image processed in accordance with an analysis result.

As a result, it is possible to provide the information collecting device in which the information indicating the abnormality of the object in the image is hardly lost when the image is collected.

The information collecting device further includes a communication control unit to transmit an image output by the image analysis unit and position information acquired by the position-information acquisition unit to an external server via a communication network.

As a result, it is possible to provide the information collecting device that efficiently collects information from the information collecting device to the server.

In the information collecting device, the resource information includes at least one piece of information indicating performance of a CPU, a memory capacity, or a resolution of an image-capturing device.

As a result, it is possible to provide the information collecting device in which the information indicating the abnormality of the object in the image is less likely to be lost in accordance with the processing capability of the information collecting device.

In the information collecting device, the processing-method determination unit determines the number of divisions of an image and a compression scheme of each of divided areas on the basis of the resource information.

As a result, it is possible to provide the information collecting device in which the information indicating the abnormality of the object in the image is less likely to be lost in accordance with the processing capability of the information collecting device while the data size of the image is efficiently reduced.

The information collecting method according to the first embodiment is an information collecting method performed by an information collecting device to collect an image and position information to be transmitted from a vehicle to an external server via a communication network, the information collecting method including causing an image acquisition unit to acquire an image of the outside of the vehicle obtained by capturing by an image-capturing device mounted on the vehicle, causing a position-information acquisition unit to acquire position information indicating a capturing position of an image acquired by the image acquisition unit, causing a resource-status acquisition unit to acquire resource information indicating a status of a resource related to a load of processing on an image, causing a processing-method determination unit to determine a processing method to be applied to an image in accordance with a status of a resource indicated by resource information acquired by the resource-status acquisition unit, causing an image processing unit to process an image in accordance with a processing method determined by the processing-method determination unit, and causing an image analysis unit to analyze an image processed by the image processing unit and output the image processed in accordance with an analysis result.

As a result, it is possible to provide the information collecting method and the information collecting device using the information collecting method in which the information indicating the abnormality of the object in the image is hardly lost when the image is collected.

### Second Embodiment

In the first embodiment, the mode in which the information collecting devices 10 each independently determine an image processing method has been described.

In a second embodiment, the mode in which an information collecting device 10′ and a server 100′ cooperate with each other will be described.

Note that, among the components according to the second embodiment, components similar to those in the first embodiment are denoted by the same reference numerals as those in the drawings used in the first embodiment, and the description thereof will be appropriately omitted.

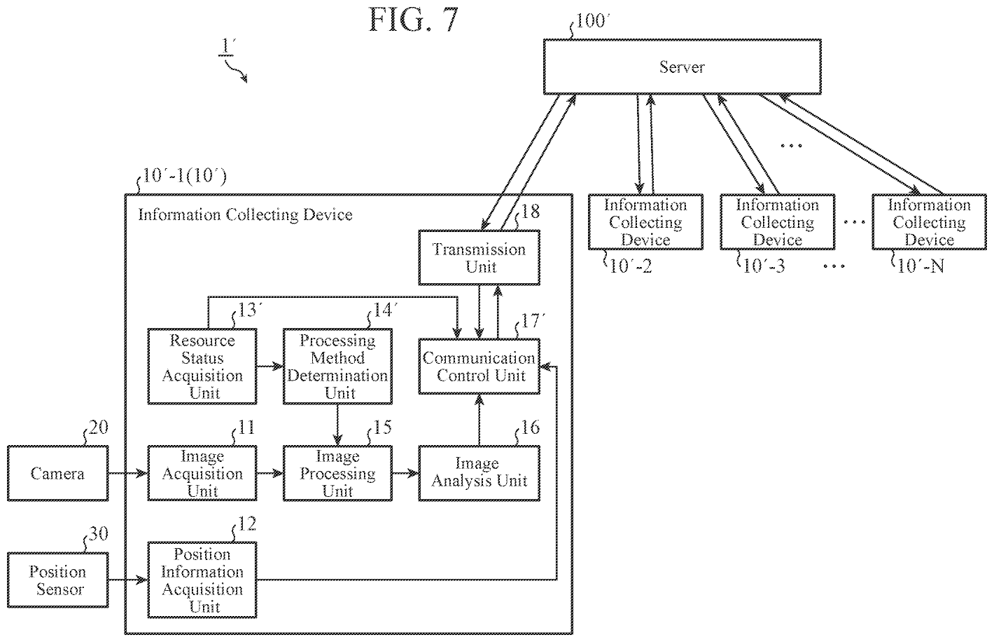

FIG. 7 is a diagram illustrating a configuration of an abnormality detection system 1′ including the information collecting device 10′ and the server 100′ according to the second embodiment.

The abnormality detection system 1′ illustrated in FIG. 7 includes the information collecting device 10′, the camera and the position sensor 30 mounted on each vehicle, and the server 100′ provided outside the vehicle.

In the abnormality detection system 1′, the camera and the position sensor 30 are similar to the camera and the position sensor 30 in the abnormality detection system 1 of the first embodiment, and the description thereof will be omitted.

The information collecting device 10′ includes the image acquisition unit 11, the position-information acquisition unit 12, a resource-status acquisition unit 13′, a processing-method determination unit 14′, the image processing unit 15, the image analysis unit 16, a communication control unit 17′, and the transmission unit 18.

The image acquisition unit 11, the position-information acquisition unit 12, the image processing unit 15, the image analysis unit 16, and the transmission unit 18 are similar to the image acquisition unit 11, the position-information acquisition unit 12, the image processing unit 15, the image analysis unit 16, and the transmission unit 18 in the information collecting device 10 of the first embodiment, respectively, and thus, the description thereof will be omitted.

The resource-status acquisition unit 13′ has a function of transmitting resource information to the communication control unit 17′ in addition to functions similar to the functions of the resource-status acquisition unit 13 of the first embodiment.

The processing-method determination unit 14′ has functions similar to the functions of the processing-method determination unit 14 of the first embodiment.

In addition, the processing-method determination unit 14′ has a function of determining a processing method in accordance with command information from the external server 100′.

Specifically, the processing-method determination unit 14′ receives the command information from the notification control unit′ and determines different processing methods depending on the contents of the command information.

The communication control unit 17′ has functions similar to the functions of the communication control unit 17 of the first embodiment.

In addition, the communication control unit 17′ has a function of receiving resource information from the resource-status acquisition unit 13′ and transmitting the resource information to the server 100′ via the transmission unit 18 and a communication network.

Furthermore, the communication control unit 17′ also has a function of receiving command information from the server 100′ via the communication network and the transmission unit 18, and transmitting the received command information to the processing-method determination unit 14.

The server 100′ has functions similar to the functions of the server 100 of the first embodiment.

In addition, the server 100′ also has a function of giving a command related to an image processing method in the information collecting device 10′ by using resource information when the resource information is notified from the information collecting device 10′.

The configuration of the server 100′ will be described.

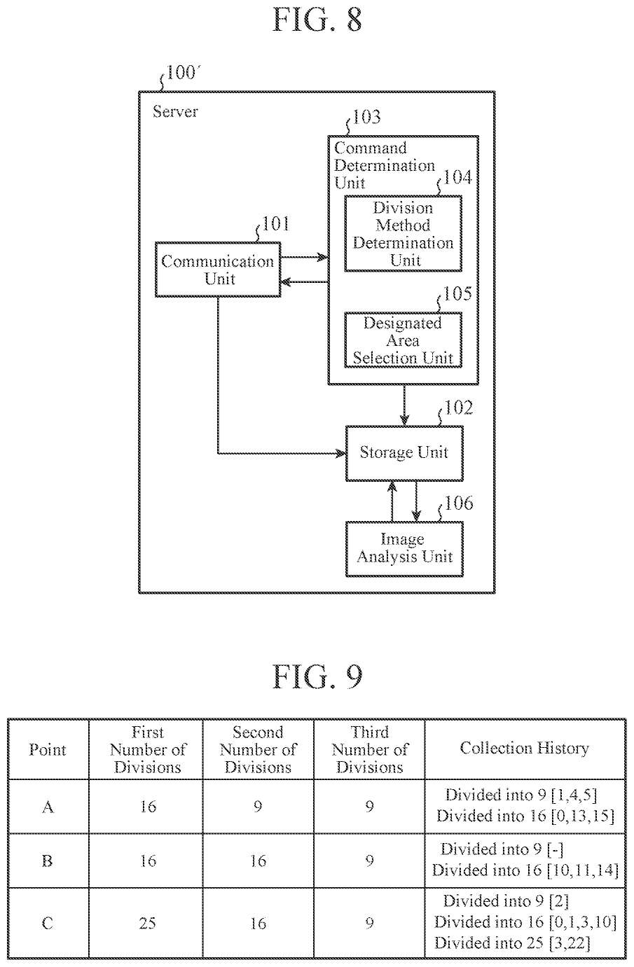

FIG. 8 is a diagram illustrating the configuration of the server 100′ according to the second embodiment.

FIG. 9 is a diagram illustrating an example of criteria for determining a processing method in the server 100′ according to the second embodiment.

As illustrated in FIG. 8, the server 100′ includes a communication unit 101, the storage unit 102, a command determination unit 103, and an image analysis unit 106.

The communication unit 101 receives an image and position information from the information collecting device 10′.

In addition, the communication unit 101 receives resource information from the information collecting device 10′ for each information collecting device 10′.

Furthermore, the communication unit 101 transmits command information indicating a command determined in the server 100′ to the information collecting device 10′.

The storage unit 102 stores the image and the position information received from the information collecting device 10′.

In addition, the storage unit 102 stores criteria for determining a processing method and a collection history.

FIG. 9 is a diagram illustrating an example of criteria for determining a processing method and a collection history in the server 100′ according to the second embodiment.

As illustrated in FIG. 9, for example, for each piece of position information such as a point A, a point B, and a point C, a first number of divisions, a second number of divisions, a third number of divisions, and collection history information are stored in advance in the storage unit 102. The first number of divisions is the number of divisions in a case where it is determined that the processing performance of the information collecting device 10′ is low, the second number of divisions is the number of divisions in a case where it is determined that the processing performance of the information collecting device 10′ is standard, and the third number of divisions is the number of divisions in a case where it is determined that the processing performance of the information collecting device 10′ is high.

The command determination unit 103 determines commands with contents such as “to command”, “to designate all processing methods”, and “not to command” in accordance with a preset command format.

The command determination unit 103 determines the number of divisions of the image and a part of the plurality of divided areas as compression areas or uncompression areas by using the resource information indicating the status of resources related to the processing load on the image in the information collecting device 10′.

Specifically, the command determination unit 103 includes a division-method determination unit 104 and a designated-area selection unit 105.

When receiving the position information and the resource information from the information collecting device 10′, the division-method determination unit 104 refers to the criteria stored in the storage unit 102 and determines the number of divisions of the image using the position information and the resource information.

Specifically, the division-method determination unit 104 specifies an image-capturing point using the position information. The division-method determination unit 104 determines the processing performance of the information collecting device 10′ by using the resource information. The division-method determination unit 104 determines the number of divisions on the basis of the criteria illustrated in FIG. 9 using the position information and the processing performance.

When the division-method determination unit 104 determines the number of divisions of the image, the designated-area selection unit 105 selects a compression area or an uncompression area using the collection history.

Specifically, the designated-area selection unit 105 selects, as the compression area, an area already collected in the images at the same position in the collection history.

In addition, the designated-area selection unit 105 may add a predetermined area as the compression area.

The image analysis unit 106 is a second image analysis unit in the abnormality detection system 1.

The image analysis unit 106 performs analysis processing of detecting an abnormality of an object in an image by using the images collected from the plurality of information collecting devices 10′.

The image analysis unit 106 performs a more detailed analysis than the image analysis unit 16 in the information collecting device 10′.

Here, an example of the contents of commands from the server 100′ to the information collecting device 10′ will be described.

The server 100′ gives, for example, the following five types of commands (1) to (5).

(1) Designate only the compression area on the basis of past information collected by the server 100

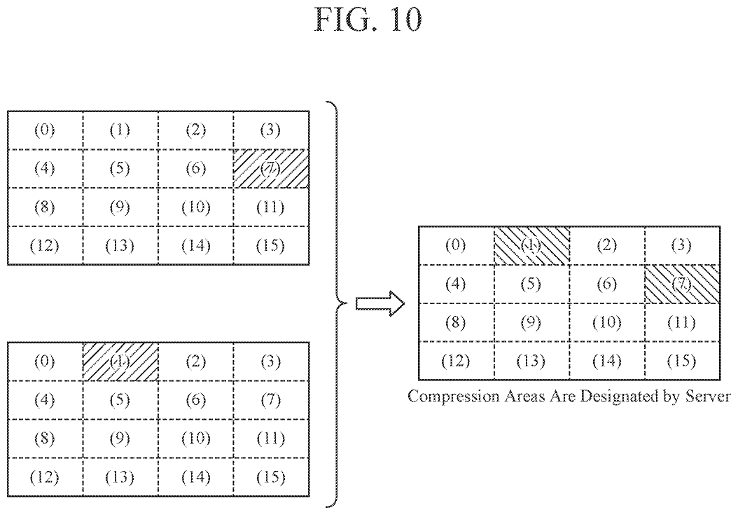

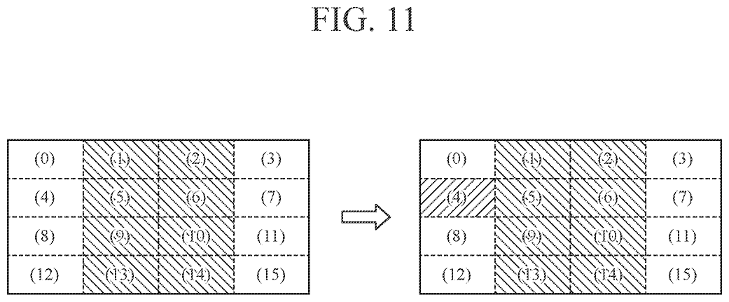

FIG. 10 is a diagram illustrating a first concept example of the contents of commands from the server 100′ to the information collecting device 10′.

In the server 100′, in a case where images in which the area (7) and the area (1) are uncompression areas are collected at the same point, the command determination unit 103 determines a command to designate the area (1) and the area (7) as compression areas.

(2) Designate Only the Static Compression Area

FIG. 11 is a diagram illustrating a second concept example of the contents of commands from the server 100′ to the information collecting device 10′.

In FIG. 11, the area (1), the area (2), the area (5), the area (6), the area (9), the area (10), the area (13), and the area (14) are fixed as the compression areas in advance.

In the server 100′, in a case where the compression area is fixed at a predetermined point, the command determination unit 103 determines a command to designate the fixed area as the compression area.

The information collecting device 10′ that has received this command can determine an area other than the designated compression area as the uncompression area.

(3) Combination of (1) and (2)

The server 100′ adds a compression area determined on the basis of the information collected from the information collecting device 10′ in addition to the statically designated compression area, and gives a command.

(4) Not to designate the number of divisions and the compression area

No designation is made from the server 100′.

As a result, in the information collecting device 10′, the image is processed by the processing method determined in accordance with the resource information.

(5) Designate the number of divisions and the uncompression area

The server 100′ gives a command to designate the number of divisions and the uncompression area.

As a result, the information collecting device 10′ does not perform the processing of determining the number of divisions and the uncompression area.

The processing performed by the information collecting device 10′ will be described.

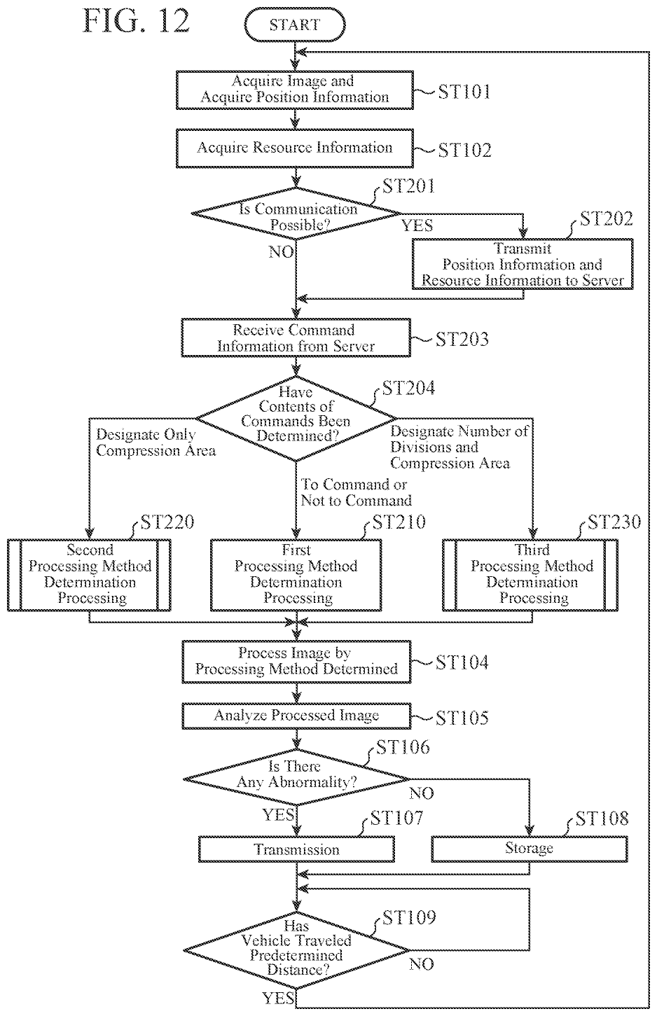

FIG. 12 is a flowchart illustrating an example of the processing performed by the information collecting device 10′ according to the second embodiment.

The information collecting device 10′ starts processing on the basis of activation or a start operation from a user.

The information collecting device 10′ acquires an image and also acquires position information (step ST101).

Specifically, when the image acquisition unit 11 in the information collecting device 10′ acquires an image from the camera and the image acquisition unit 11 acquires the image, the position-information acquisition unit 12 acquires position information from the position sensor 30.

The image acquisition unit 11 outputs the acquired image. The output image is transmitted to the image processing unit 15.

The position-information acquisition unit 12 outputs the acquired position information. The output position information is transmitted to the communication control unit 17.

The resource-status acquisition unit checks the CPU and the memory in the information collecting device 10′, and acquires resource information including the CPU usage rate and the memory usage rate (step ST102).

The resource-status acquisition unit outputs the resource information.

The communication control unit 17′ determines whether communication with the external server 100′ via the communication network is possible (step ST201).

If communication is not possible (step ST201 “NO”), the communication control unit 17′ waits for the reception of command information from the server 100′.

If communication is possible (step ST201 “YES”), the communication control unit 17′ acquires the position information from the position-information acquisition unit 12 and acquires the resource information from the resource-status acquisition unit.

The communication control unit 17′ transmits the position information and the resource information to the server 100′ via the transmission unit 18 and the communication network (step ST202).

When the processing in step ST202 is performed, the communication control unit 17′ waits for the reception of the command information from the server 100′.

When receiving the command information from the server 100′ (step ST203), the communication control unit 17′ transmits the command information to the processing-method determination unit 14′.

The processing-method determination unit 14′ analyzes the command information and determines the contents of commands (step ST204).

If the processing-method determination unit 14′ determines that the contents of commands include “not to command” or “not to designate area”, the processing proceeds to first processing-method determination processing (step ST210).

An example of the first processing-method determination processing will be described later.

If the contents of commands include “to designate only compression area”, the processing-method determination unit 14′ proceeds to second processing-method determination processing (step ST220).

An example of the second processing-method determination processing will be described later.

If the contents of commands include “designate number of divisions and compression area”, the processing-method determination unit 14′ proceeds to third processing-method determination processing (step ST230).

An example of the third processing-method determination processing will be described later.

The processing-method determination unit 14′ proceeds to processing in step ST104 through the processing in step ST210, step ST220, or step ST230.

Since processing from step ST104 to step ST109 is similar to that of the first embodiment, a detailed description thereof will be omitted.

An example of the first processing-method determination processing (step ST210) will be described.

In step ST210, the processing-method determination unit 14′ determines a processing method using the resource information, as in step ST103 described in the first embodiment.

The processing-method determination unit 14′ outputs processing method information indicating the processing method.

Subsequently, the information collecting device 10′ proceeds to the processing in step ST104.

An example of the second processing-method determination processing (step ST220) will be described.

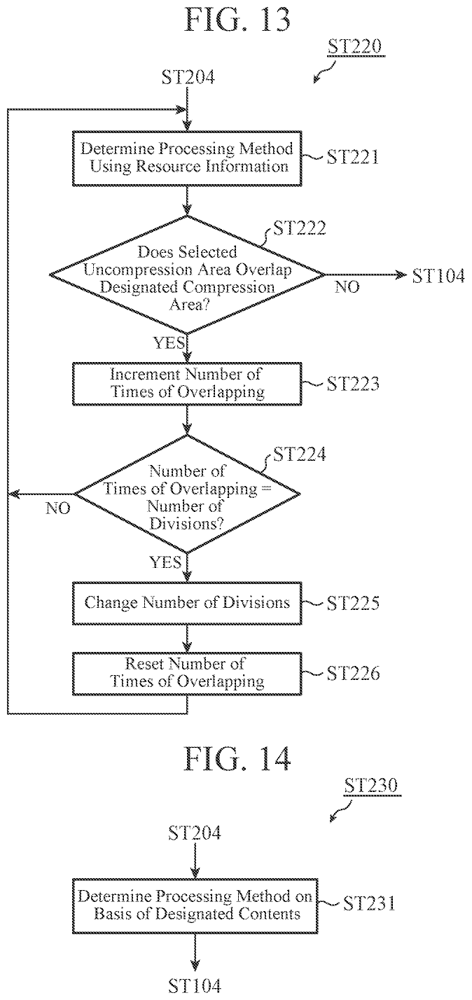

FIG. 13 is a flowchart illustrating an example of the processing in step ST220 in FIG. 12.

The processing-method determination unit 14′ first determines a processing method using the resource information (step ST221).

Specifically, the number of divisions is determined in accordance with the resource information, and the uncompression area is determined from areas other than the designated compression area among the divided areas.

It is determined whether the selected uncompression area overlaps the designated compression area (step ST222).

When determining in step ST222 that there is an overlap (step ST222 “NO”), the processing-method determination unit 14′ increments the number of times of overlapping (step ST223).

The processing-method determination unit 14′ determines whether the number of times of overlapping is equal to the number of divisions in the determined processing method (number of times of overlapping=number of divisions?) (step ST224).

If the number of times of overlapping is not equal to the number of divisions in the processing method determined in step ST221 (step ST224 “NO”), the processing returns to step ST221.

If the number of times of overlapping is equal to the number of divisions in the processing method determined in step ST221 (step ST224 “YES”), the number of divisions is changed (step ST225).

Subsequently, the number of times of overlapping is reset (step ST226), and the processing returns to step ST221.

When determining in step ST222 that there is no overlap (step ST222 “NO”), the information collecting device 10′ proceeds to the processing in step ST104.

An example of the third processing-method determination processing (step ST230) will be described.

FIG. 14 is a flowchart illustrating an example of the processing in step ST230 in FIG. 12.

The processing-method determination unit 14′ determines a processing method in accordance with the designated contents (step ST231).

When determining the processing method, the information collecting device 10′ proceeds to the processing in step ST104.

The processing in the server 100′ will be described. Here, the processing using the criteria and the collection history illustrated in FIG. 9 will be described.

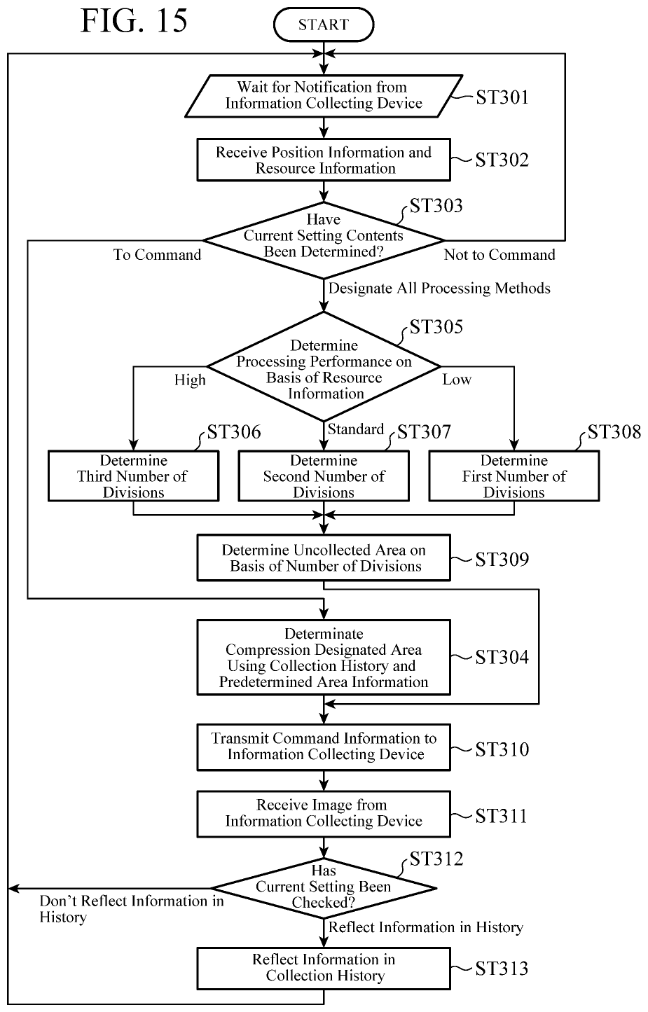

FIG. 15 is a flowchart illustrating the processing in the server 100′ according to the second embodiment.

The server 100′ waits for a notification from the information collecting device 10′ (step ST301).

When receiving the position information and the resource information from the information collecting device 10′ (step ST302), the command determination unit 103 determines the current setting contents (step ST303).

If the current setting contents include “not to command”, the processing returns to step ST301.

If the current setting contents include “to command”, the designated-area selection unit determines a compression designated area using the collection history and predetermined area information (step ST304). Then, the processing proceeds to step ST310.

If the current setting contents include “designate all processing methods”, the division-method determination unit determines the processing performance of the information collecting device 10′ on the basis of the resource information (step ST305).

If it is determined in step ST305 that the processing performance is “high”, the division-method determination unit determines the third number of divisions (step ST306).

If it is determined in step ST305 that the processing performance is “standard”, the division-method determination unit determines the second number of divisions (step ST307).

If it is determined in step ST305 that the processing performance is “low”, the division-method determination unit determines the first number of divisions (step ST308).

Subsequently, the designated-area selection unit determines an uncollected area from areas that have not yet been collected in accordance with the number of divisions by using the collection history (step ST309).

Then, the processing proceeds to step ST310.

In step ST310, the communication unit 101 receives the command information from the command determination unit 103 and transmits the command information to the information collecting device 10′.

The information collecting device 10′ performs processing in accordance with the command information accordingly, and transmits an image.

Then, the server 100′ receives the position information and the image from the information collecting device 10′ (step ST311).

Subsequently, the current setting is checked (step ST312).

If the current setting is “reflect information in history”, the command determination unit 103 reflects the current setting in the collection history (step ST313).

If the current setting is “not to reflect information in history”, the processing returns to the processing in step ST301 without changing the collection history.

Note that the hardware configurations of the information collecting device 10′ and the server 100′ according to the second embodiment are similar to those in the first embodiment, and thus the description thereof will be omitted.

In the information collecting device according to the second embodiment, in addition to the first embodiment, the communication control unit transmits resource information acquired by the resource-status acquisition unit to an external server, and after transmitting the resource information, receives a command of an information collecting method from the external server, and the processing-method determination unit determines a processing method in accordance with a command of an information collecting method received by the communication control unit.

As a result, it is possible to provide the information collecting device that efficiently collects information from and to the server.

The server according to the second embodiment is a server to collect an image and position information from an information collecting device mounted on a vehicle via a communication network, the server including a command determination unit to, when receiving resource information indicating a status of a resource related to a load of processing on an image from the information collecting device, determine the number of divisions of an image and a part of a plurality of areas obtained by dividing the image as a compression area or an uncompression area using the resource information, and a communication unit to notify the information collecting device of the number of divisions and an area determined by the command determination unit.

As a result, it is possible to provide the server in which the information indicating the abnormality of the object in the image is hardly lost when the image is collected.

Note that it is possible to freely combine the embodiments, modify any component of each embodiment, or omit any component of each embodiment within the scope of the present disclosure.

### INDUSTRIAL APPLICABILITY

The information collecting device according to the present disclosure is suitable for use in an abnormality detection system or the like that collects an image of the outside of a vehicle obtained by capturing from the vehicle.

### REFERENCE SIGNS LIST

1, 1′: abnormality detection system, 10, 10-1, 10-2, 10-3, 10-N, 10′, 10′-1, 10′-2, 10′-3, 10′-N: information collecting device, 11: image acquisition unit, 12: position-information acquisition unit, 13, 13′: resource-status acquisition unit, 14, 14′: processing-method determination unit, 15: image processing unit, 16: image analysis unit, 17, 17′: communication control unit, 18: transmission unit, 20: camera (image-capturing device), 30: position sensor, 100, 100′: server, 101: communication unit, 102: storage unit, 103: command determination unit, 104: division-method determination unit, 105: designated-area selection unit, 106: image analysis unit, 1000: image, 1001: uncompression area, 1002: compression area, 2001: processor, 2002: memory, 2003: processing circuit

1. An information collecting device to collect an image and position information to be transmitted from a vehicle to an external server via a communication network, the information collecting device comprising processing circuitry
to acquire the image of outside of the vehicle obtained by capturing by an image-capturing device mounted on the vehicle,
to acquire position information indicating a capturing position of the image,
to acquire resource information indicating a status of a resource related to a load of processing on the image,
to determine a processing method of the image in accordance with the status of the resource indicated by the resource information,
to process the image in accordance with the processing method, and
to perform analysis of the image processed and output the image processed in accordance with a result of the analysis.

2. The information collecting device according to claim 1, wherein the processing circuitry further performs to transmit the image output by the processing circuitry and the position information to an external server via a communication network.

3. The information collecting device according to claim 1, wherein the resource information includes at least one piece of information indicating performance of a CPU, a memory capacity, or a resolution of an image-capturing device.

4. The information collecting device according to claim 1, wherein the processing circuitry determines the number of divisions of the image when the image is divided into a plurality of divided areas and a compression scheme of each of the plurality of divided areas on a basis of the resource information.

5. The information collecting device according to claim 1, wherein
the processing circuitry transmits resource information to an external server, and after transmitting the resource information, receives a command of an information collecting method from the external server, and
the processing circuitry determines a processing method in accordance with the command of the information collecting method.

6. A server to collect an image and position information from an information collecting device mounted on a vehicle via a communication network, the server comprising processing circuitry
to, when receiving resource information indicating a status of a resource related to a load of processing on the image from the information collecting device, determine the number of divisions of the image when the image is divided into a plurality of divided areas and a part of the plurality of divided areas as a compression area or an uncompression area using the resource information; and
to notify the information collecting device of the number of divisions and the part of the plurality of divided areas.

7. An information collecting method performed by an information collecting device to collect an image and position information to be transmitted from a vehicle to an external server via a communication network, the information collecting method comprising:
acquiring the image of outside of the vehicle obtained by capturing by an image-capturing device mounted on the vehicle;
acquiring position information indicating a capturing position of the image;
acquiring resource information indicating a status of a resource related to a load of processing on the image;
determining a processing method of the image in accordance with a status of the resource indicated by the resource information;
processing the image in accordance with the processing method; and
performing analysis of the image processed by the processing circuitry and outputting the image processed in accordance with a result of the analysis.
